(19) United States
(12) Patent Application Publication
(10) Pub. No.: US 2016/0113451 A1
(43) Pub. Date: Apr. 28, 2016

(54) HAND DRYING ASSEMBLY

(71) Applicant: Dolores Faber, Northport, NY (US)

(72) Inventor: Dolores Faber, Northport, NY (US)

(21) Appl. No.: 14/523,107

(22) Filed: Oct. 24, 2014

(51) Int. Cl. A47K 10/48; H05B 3/02; H05B 1/02

(52) U.S. Cl. CPC A47K 10/48; H05B 1/0252; H05B 3/02

(57) ABSTRACT

A hand drying assembly includes a housing structured to have a front portion hingedly coupled to a back portion such that the front portion is positionable at a selected angle with respect to the back portion. The back portion may be coupled to a support surface such that the front portion is accessible to a user. An outlet is movably coupled to a distal end of the front portion with respect the back portion. A motor is positioned within the front portion. An actuator is coupled to the front portion. The actuator is electrically coupled to the motor such that the actuator actuates and de-actuates the motor. A fan is coupled to the motor. The fan urges air outwardly through the outlet onto the user's hands. A heating coil is positioned within the front portion such that the fan urges the air over the heating coil. The heating coil is electrically coupled to the actuator.

### BACKGROUND OF THE DISCLOSURE

### Field of the Disclosure

The disclosure relates to drying devices and more particularly pertains to a new drying device for drying a user's hands.

### SUMMARY OF THE DISCLOSURE

An embodiment of the disclosure meets the needs presented above by generally comprising a housing structured to have a front portion hingedly coupled to a back portion such that the front portion is positionable at a selected angle with respect to the back portion. A distal end of the front portion with respect to the back portion is open. The back portion is coupled to a support surface such that the front portion is accessible to a user. An outlet is movably coupled to the distal end of the front portion such that the outlet is positionable at a selected orientation with respect to the front portion. A motor is positioned within the front portion. An actuator is coupled to the front portion. The actuator is electrically coupled to the motor such that the actuator actuates and de-actuates the motor. A fan is coupled to the motor. The motor rotates the fan such that the fan urges air outwardly through the outlet. A heating coil is positioned within the front portion such that the fan urges the air over the heating coil. The heating coil is electrically coupled to the actuator to heat the air.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a hand drying assembly according to an embodiment of the disclosure.

FIG. 2 is a top view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 3 of an embodiment of the disclosure.

FIG. 5 is an in-use view of an embodiment of the disclosure.

### DESCRIPTION OF THE PREFERRED EMBODIMENT

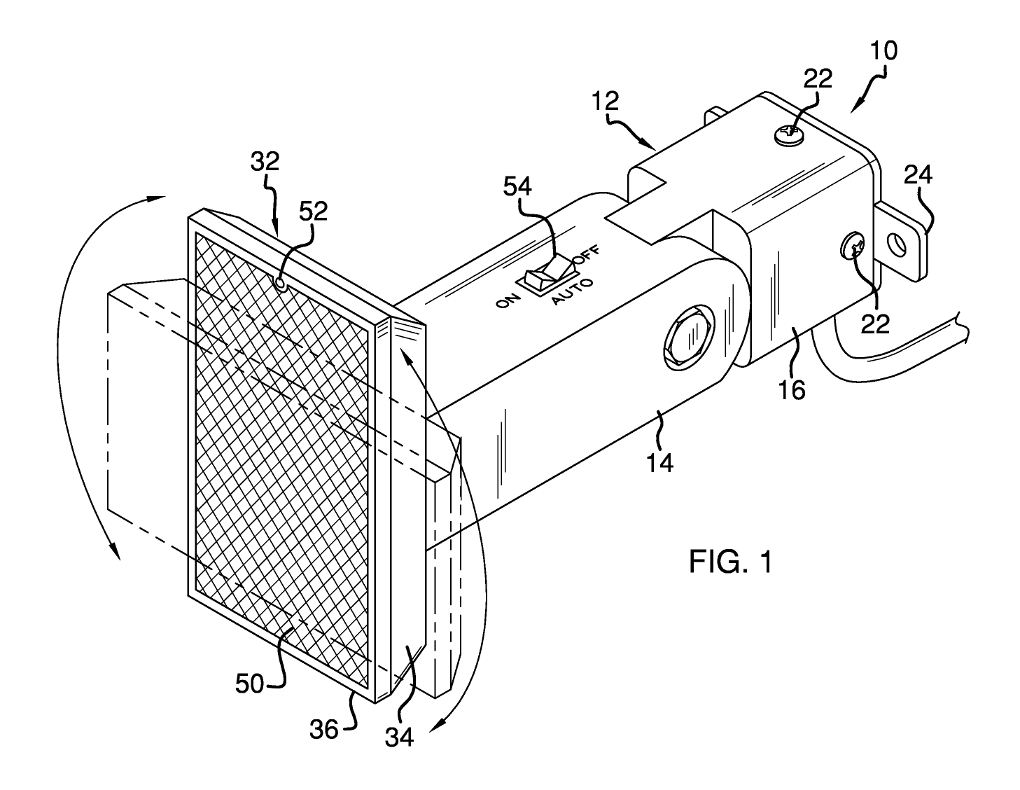

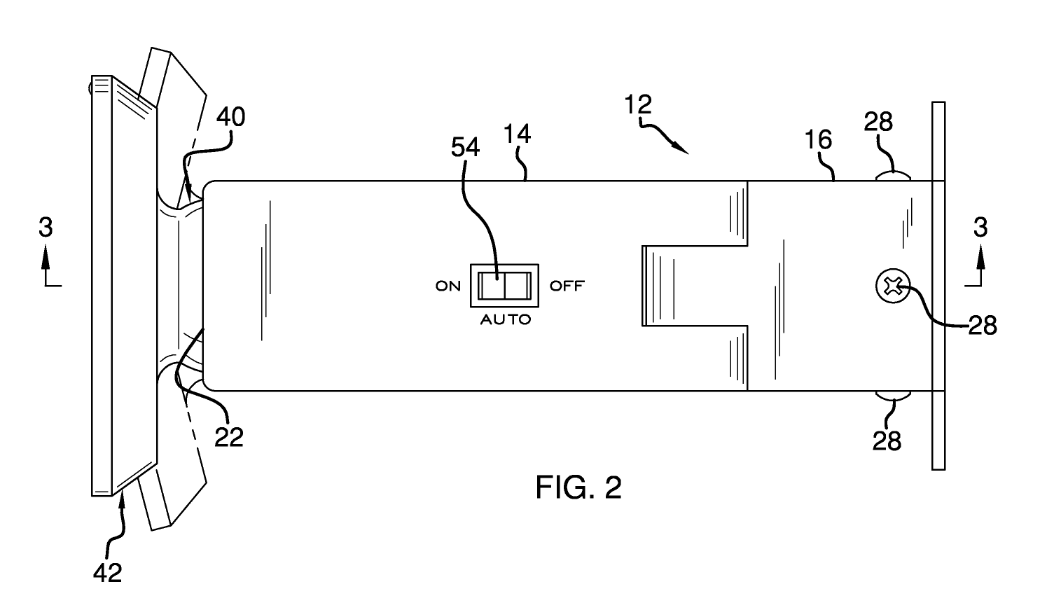

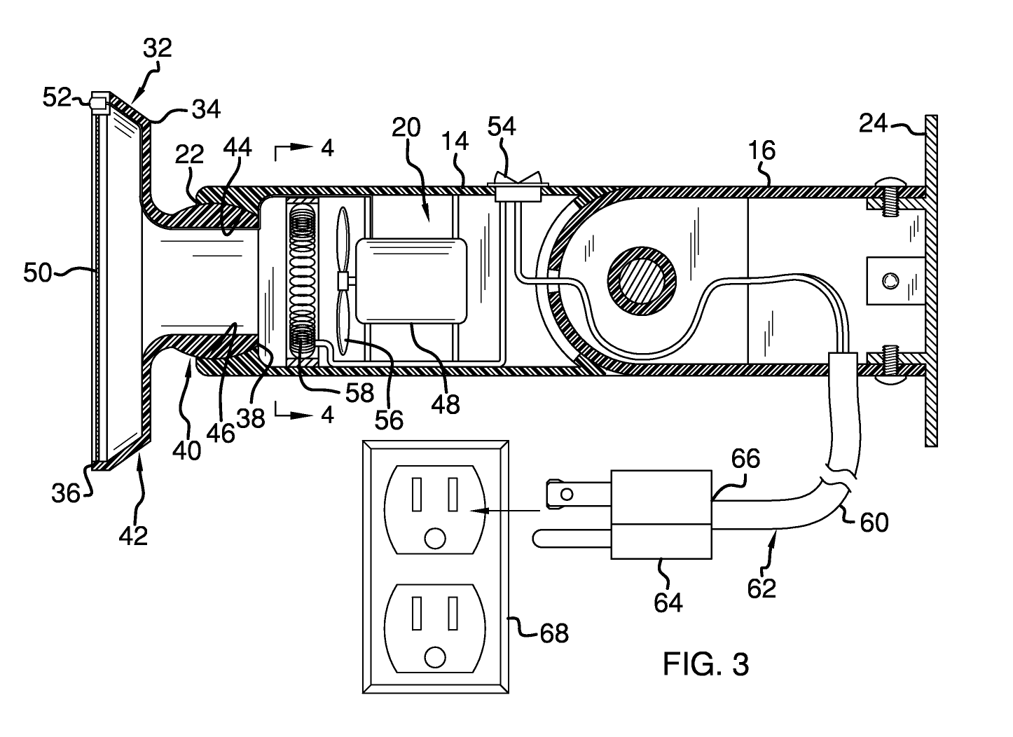

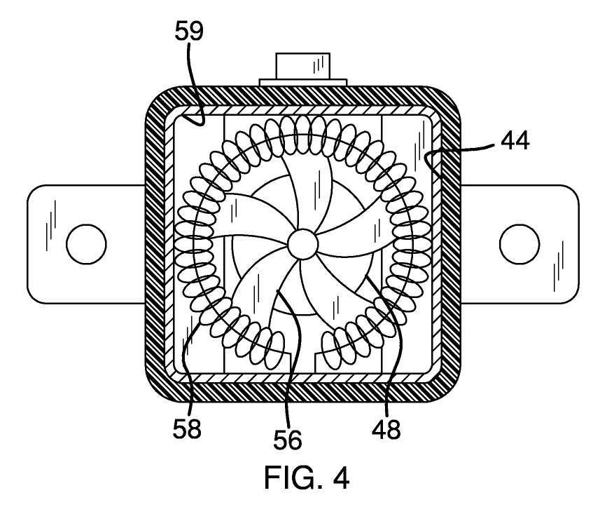

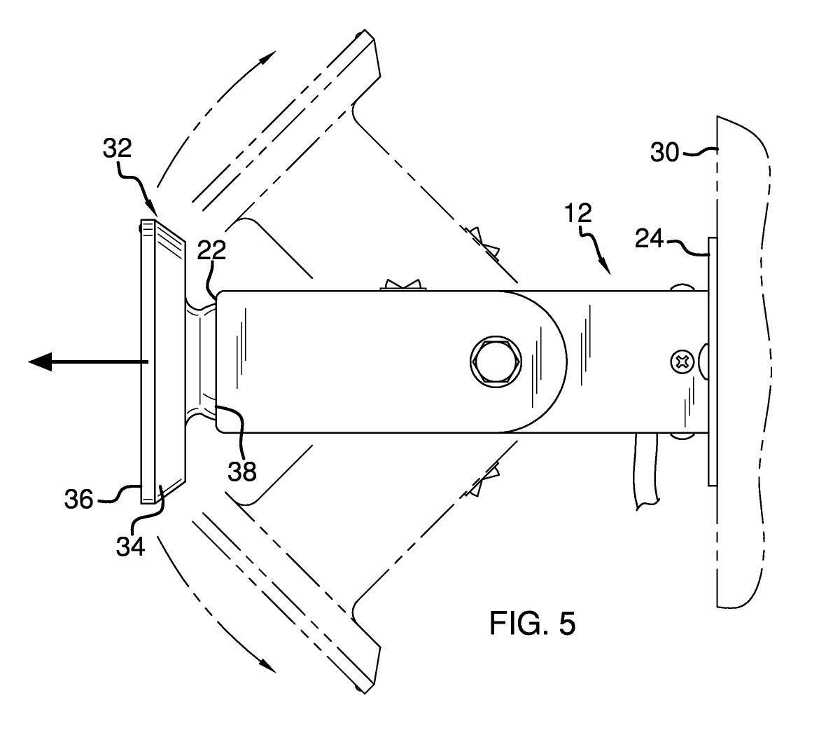

With reference now to the drawings, and in particular to FIGS. 1 through 5 thereof, a new drying device embodying the principles and concepts of an embodiment of the disclosure and generally designated by the reference numeral 10 will be described.

As best illustrated in FIGS. 1 through 5, the hand drying assembly 10 generally comprises a housing 12 structured to have a front portion 14 hingedly coupled to a back portion 16 such that the front portion 14 is positionable at a selectable angle with respect to the back portion 16. The front portion 14 is substantially hollow to define a motor space 20 within the front portion 14. A distal end 22 of the front portion 14 with respect to the back portion 16 is open.

A bracket 24 is coupled to a back end 26 of the back portion 16. Each of a plurality of screws 28 extends through the back portion 16 and engages the bracket 24 to retain the bracket 24 on the back portion 16. The bracket 24 is coupled to a support surface 30 such that the front portion 14 is accessible to a user. The support surface 30 may be a vertical support surface or the like. Additionally, the vertical support surface 30 may be located within a bathroom or the like.

An outlet 32 is provided. The outlet 32 has an outer wall 34 extending between each of a front end 36 and a rear end 38 of the outlet 32. Each of the front end 36 and the rear end 38 of the outlet 32 are open. The outer wall 34 defines a coupling portion 40 extending rearwardly from a blowing portion 42 of the outlet 32. The outer wall 34 corresponding to the coupling portion 40 is curvilinear such that the coupling portion 40 has a ball shape.

An inner surface 44 of the front portion 14 is concave proximate the distal end 22. The distal end 22 insertably receives the coupling portion 40 such that the outlet 32 is in fluid communication with the motor space 20. The outer wall 34 of the outlet 32 corresponding to the coupling portion 40 engages the concave section 46 of the inner surface 44 of the front portion 14 so the outlet 32 is positionable at a selected orientation with respect to the front portion 14.

A motor 48 is positioned within the motor space 20. The motor 48 may be an electrical motor or the like. A screen 50 is coupled to the outlet 32 to completely cover the front end 36. A motion sensor 52 is coupled to the front end 36. The motion sensor 52 is electrically coupled to the motor 48. The motion sensor 52 detects when the user has moved to within a trigger distance of the housing 12.

An actuator 54 is coupled to the front portion 14. The actuator 54 is electrically coupled to the motor 48. The actuator 54 is positionable in an on position to actuate the motor 48. The actuator 54 is positionable in an off position to de-actuate the motor 48. Additionally, the actuator 54 is positionable in an auto position. The motion sensor 52 actuates the motor 48 when the actuator 54 is in the auto position.

A fan 56 is coupled to the motor 48. The motor 48 rotates the fan 56 such that the fan 56 urges air outwardly through the outlet 32 onto the user's hands. Thus, the assembly 10 dries the user's hands. A heating coil 58 is provided. The heating coil 58 is electrically coupled to the actuator 54. Moreover, the heating coil 58 is positioned between the motor 48 and the outlet 32 such that the fan 56 urges the air over the heating coil 58. Thus, the heating coil 58 heats the air.

An insulator 59 is coupled to the inner surface 44 of the front portion 14. The insulator is positioned between the heating coil 58 and the inner surface 44 of the front portion 14. The insulator insulates the front portion 14 from the heat of the heating coil 58.

A power supply 60 is coupled to the back portion 16. The power supply 60 is electrically coupled to the actuator 54. Additionally, the power supply 60 comprises a power cord 62 extending outwardly from the back portion 16. A plug 64 is coupled to a free end 66 of the power cord 62. The plug 64 is electrically coupled to a power source 68. The power source 68 may be an electrical outlet or the like.

In use, the actuator 54 is positioned in the selected position. The outlet 32 is positioned at the selected orientation. The user rubs the user's hands in front of the outlet 32 so the heated air dries the user's hands.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hand drying assembly comprising:
a housing structured to have a front portion hingedly coupled to a back portion such that said front portion is positionable at a selected angle with respect to said back portion, a distal end of said front portion with respect to said back portion being open, said back portion being configured to be coupled to a support surface such that said front portion is accessible to a user;
an outlet movably coupled to said distal end of said front portion such that said outlet is positionable at a selected orientation with respect to said front portion;
a motor positioned within said front portion;
an actuator coupled to said front portion, said actuator being electrically coupled to said motor such that said actuator actuates and de-actuates said motor;
a fan coupled to said motor, said motor rotating said fan such that said fan urges air outwardly through said outlet onto the user's hands wherein said assembly is configured to dry the user's hands; and
a heating coil positioned within said front portion such that said fan urges the air over said heating coil wherein said heating coil is configured to heat the air, said heating coil being electrically coupled to said actuator.

2. The assembly according to claim 1, further comprising said outlet having an outer wall extending between each of a front end and a rear end of said outlet, said front and rear ends of said outlet being open, said outer wall defining a coupling portion extending rearwardly from a blowing portion of said outlet, said outer wall corresponding to said coupling portion being curvilinear such that said coupling portion has a ball shape.

3. The assembly according to claim 2, further comprising said front portion being substantially hollow to define a motor space, said distal end insertably receiving said coupling portion such that said outlet is in fluid communication with said motor space.

4. The assembly according to claim 3, further comprising:
a power supply coupled to said back portion, said power supply being electrically coupled to said actuator, said power supply comprising a power cord extending outwardly from said back portion; and
a plug coupled to a free end of said power cord, said plug being electrically coupled to a power source.

5. A hand drying assembly comprising:
a housing structured to have a front portion hingedly coupled to a back portion such that said front portion is positionable at a selected angle with respect to said back portion, said front portion being substantially hollow to define a motor space, a distal end of said front portion with respect to said back portion being open, said back portion being coupled to a support surface such that said front portion is accessible to a user;
an outlet, said outlet having an outer wall extending between each of a front end and a rear end of said outlet, said front and rear ends of said outlet being open, said outer wall defining a coupling portion extending rearwardly from a blowing portion of said outlet, said outer wall corresponding to said coupling portion being curvilinear such that said coupling portion has a ball shape;
said distal end insertably receiving said coupling portion such that said outlet is in fluid communication with said motor space, said outlet being positionable at a selected orientation with respect to said front portion;
a motor positioned within said motor space;
an actuator coupled to said front portion, said actuator being electrically coupled to said motor such that said actuator actuates and de-actuates said motor;
a fan coupled to said motor, said motor rotating said fan such that said fan urges air outwardly through said outlet onto the user's hands wherein said assembly is configured to dry the user's hands;
a heating coil positioned between said motor and said outlet such that said fan urges the air over said heating coil wherein said heating coil is configured to heat the air, said heating coil being electrically coupled to said actuator;
a power supply coupled to said back portion, said power supply being electrically coupled to said actuator, said power supply comprising a power cord extending outwardly from said back portion; and
a plug coupled to a free end of said power cord, said plug being electrically coupled to a power source.
